(19) United States
(12) Patent Application Publication
(10) Pub. No.: US 2015/0114152 A1
(43) Pub. Date: Apr. 30, 2015

(54) POWER TRANSMITTING APPARATUS FOR VEHICLE

(71) Applicant: Hyundai Motor Company, Seoul (KR)

(72) Inventors: Sueng Ho LEE, Seoul (KR); Chang Wook LEE, Suwon-si (KR); Jongsool PARK, Hwaseong-si (KR)

(73) Assignee: Hyundai Motor Company, Seoul (KR)

(21) Appl. No.: 14/339,066

(22) Filed: Jul. 23, 2014

(30) Foreign Application Priority Data
Oct. 28, 2013 (KR) 10-2013-0128678

(51) Int. Cl. F16H 3/093

(52) U.S. Cl. CPC F16H 3/093; F16H 2200/0056
USPC 74/330

(57) ABSTRACT

A power transmitting apparatus for a vehicle may include first and second input shafts selectively receiving torque of a power source through first and second clutches, first and second output shafts disposed in parallel with the first and second input shafts, a plurality of input gears disposed on the first and second input shafts, and at least six speed gears selectively connected to the first and second output shafts through a plurality of synchronizer modules.

### CROSS-REFERENCE TO RELATED APPLICATION

The present application claims priority to and the benefit of Korean Patent Application No. 10-2013-0128678 filed on Oct. 28, 2013, the entire contents of which is incorporated herein for all purposes by this reference.

### BACKGROUND OF THE INVENTION

1. Field of the Invention

More particularly, the present invention relates to a power transmitting apparatus for a vehicle which improves mountability by minimizing a length of the power transmitting apparatus and enhances drivability and fuel economy by preventing distortion of step ratios.

2. Description of Related Art

Environmentally-friendly technique of vehicles is very important technique on which survival of future motor industry is dependent. Vehicle makers are focusing on development of environmentally-friendly vehicles so as to meet environment and fuel consumption regulations.

Some examples of future vehicle technique are an electric vehicle (EV) and a hybrid electric vehicle (HEV) that use electrical energy, and double clutch transmission (DCT) that improves efficiency and convenience.

The DCT includes two clutch devices and a gear train applied to a manual transmission. The DCT selectively transmits torque input from an engine to two input shafts by using two clutches, changes a speed by using the gear train, and outputs the changed torque.

Such the DCT is used to realize a compact transmission having more than five forward speeds. Since two clutches and synchronizing devices are controlled by a controller according to the DCT, manual shift maneuver is unnecessary for controlling the DCT. Therefore, the DCT is one type of automated manual transmissions (AMT).

The DCT, compared with an automatic transmission using planetary gear sets, has excellent power delivery efficiency and change and addition of components is very easy in the DCT. Therefore, the DCT can meet fuel consumption regulations and multi-speeds efficiency may be improved.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a power transmitting apparatus for a vehicle having advantages of improving mountability by minimizing a length of the power transmitting apparatus and enhancing drivability and fuel economy by preventing distortion of step ratios.

In an aspect of the present invention, a power transmitting apparatus for a vehicle may include first and second input shafts selectively receiving torque of a power source through first and second clutches, first and second output shafts disposed in parallel with the first and second input shafts, a plurality of input gears disposed on the first and second input shafts, and at least six speed gears selectively connected to the first and second output shafts through a plurality of synchronizer modules, wherein each speed gear is always engaged with each input gear such that the torque of the power source is changed by selective operation of the plurality of synchronizer modules and the changed torque is transmitted to the first output shaft or the second output shaft, wherein one of the speed gears on the first output shaft and one of the speed gears on the second output shaft are engaged to any one of the input gears on the first input shaft, the one speed gear on the first output shaft is one of a highest shift-speed (N^{th}) speed gear and an (N−4)^{th} speed gear, and the one speed gear on the second output shaft is the other of the N^{th} speed gear and the (N−4)^{th} speed gear, and wherein another speed gear on the first output shaft and another speed gear on the second output shaft are engaged to any one of the input gears on the second input shaft, another speed gear on the first output shaft is one of an (N−3)^{th} speed gear and an (N−5)^{th} speed gear, and another speed gear on the second output shaft is the other of the (N−3)^{th} speed gear and the (N−5)^{th} speed gear.

The highest shift-speed (N^{th}) is any one of the sixth forward speed to the tenth forward speed.

The second input shaft is a hollow shaft and the first input shaft penetrates the second input shaft and is disposed coaxially with the second input shaft.

First, second, and third input gears of the input gears are sequentially disposed on the first input shaft, and fourth, fifth, and sixth input gears of the input gears are sequentially disposed on the second input shaft.

The speed gears may include a reverse speed gear, and the power transmitting apparatus may further include a reverse speed device including a reverse speed shaft disposed in parallel with the second output shaft, a reverse input gear disposed on the reverse speed shaft and engaged with any one input gear on the second input shaft, and a reverse output gear disposed on the reverse speed shaft and engaged with the reverse speed gear.

The fourth input gear on the second input shaft is engaged with the reverse input gear.

The first input shaft is a hollow shaft and the second input shaft penetrates the first input shaft and is disposed coaxially with the first input shaft.

First, second, and third input gears of the input gears are sequentially disposed on the first input shaft, and fourth, fifth, and sixth input gears of the input gears are sequentially disposed on the second input shaft.

The speed gears may include a reverse speed gear, and the power transmitting apparatus may further include a reverse speed device including a reverse speed shaft disposed in parallel with the second output shaft, a reverse input gear disposed on the reverse speed shaft and engaged with any one input gear on the second input shaft, and a reverse output gear disposed on the reverse speed shaft and engaged with the reverse speed gear.

The fourth input gear on the second input shaft is engaged with the reverse input gear.

In another aspect of the present invention, a power transmitting apparatus for a vehicle, may include first and second input shafts selectively receiving torque of a power source through first and second clutches, first and second output shafts disposed in parallel with the first and second input shafts, a plurality of input gears disposed on the first and second input shafts, and eight speed gears including a reverse speed gear selectively connected to the first and second output shafts through a plurality of synchronizer modules, wherein each speed gear is always engaged with each input gear such that the torque of the power source is changed by selective operation of the plurality of synchronizer modules and the changed torque is transmitted to the first output shaft or the second output shaft, and wherein a seventh speed gear on the first output shaft and a third speed gear on the second output shaft are engaged with any one input gear on the first input shaft, and a fourth speed gear on the first output shaft and a second speed gear on the second output shaft are engaged with any one input gear on the second input shaft.

The second input shaft is a hollow shaft and the first input shaft penetrates the second input shaft, and first, second, and third input gears are sequentially disposed on the first input shaft, and fourth, fifth, and sixth input gears are sequentially disposed on the second input shaft.

The power transmitting apparatus may further include a reverse speed device including a reverse speed shaft disposed in parallel with the second output shaft, a reverse input gear disposed on the reverse speed shaft and engaged with any one input gear on the second input shaft, and a reverse output gear disposed on the reverse speed shaft and engaged with the reverse speed gear.

The fourth input gear on the second input shaft is engaged with the reverse input gear.

The first input shaft is a hollow shaft and the second input shaft penetrates the first input shaft, and first, second, and third input gears are sequentially disposed on the first input shaft, and fourth, fifth, and sixth input gears are sequentially disposed on the second input shaft.

A reverse speed device including a reverse speed shaft disposed in parallel with the second output shaft, a reverse input gear disposed on the reverse speed shaft and engaged with any one input gear on the second input shaft, and a reverse output gear disposed on the reverse speed shaft and engaged with the reverse speed gear.

The fourth input gear on the second input shaft is engaged with the reverse input gear.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a power transmitting apparatus for a vehicle according to various exemplary embodiments of the present invention.

FIG. 2 is an operational chart of a power transmitting apparatus for a vehicle according to the various exemplary embodiments of the present invention.

FIG. 3 is a table illustrating gear ratios and step ratios of power transmitting apparatus for a vehicle according to the various exemplary embodiments of the present invention.

FIG. 4 is a schematic diagram of a power transmitting apparatus for a vehicle according to the various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will hereinafter be described in detail with reference to the accompanying drawings.

Description of components that are not necessary for explaining the present exemplary embodiment will be omitted, and the same constituent elements are denoted by the same reference numerals in this specification.

In the detailed description, ordinal numbers are used for distinguishing constituent elements having the same terms, and have no specific meanings.

In addition, it is exemplified but is not limited in the exemplary embodiments of the present invention that a highest shift-speed is a seventh forward speed. The highest shift-speed may be any one of a fifth forward speed to a tenth forward speed within the scope of the present invention.

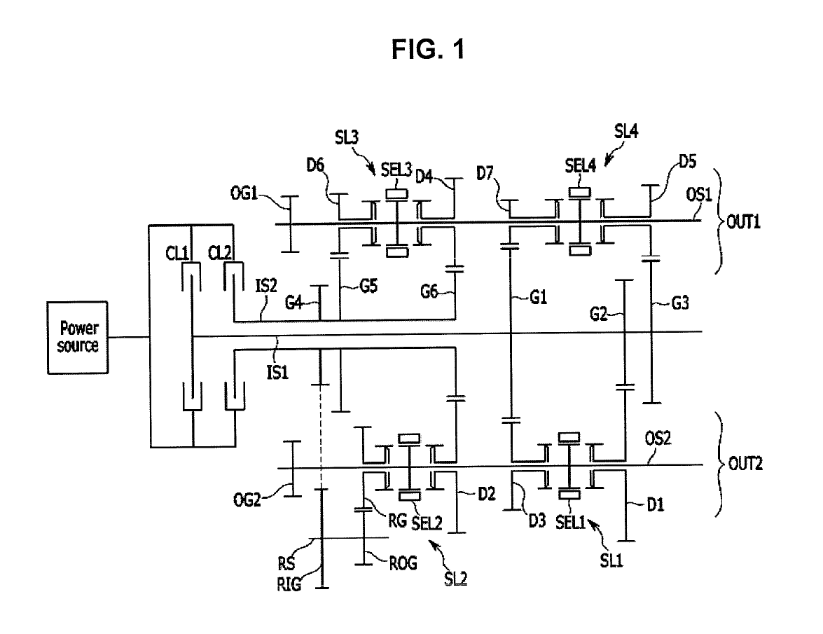

FIG. 1 is a schematic diagram of a power transmitting apparatus for a vehicle according to the first exemplary embodiment of the present invention.

Referring to FIG. 1, a power transmitting apparatus for a vehicle according to the first exemplary embodiment of the present invention includes first and second clutches CL1 and CL2 for selectively transmitting torque of a power source.

The power source may be an engine in a case of a typical vehicle provided with an internal combustion engine and a manual or an automatic transmission, and may be a motor in a case of a hybrid electric vehicle including an electric vehicle.

The first clutch CL1 and the second clutch CL2 selectively transmits torque of the power source respectively to first and second input shafts IS1 and IS2.

That is, the first clutch CL1 selectively connects the first input shaft IS1 with the power source and the second clutch CL2 selectively connects the second input shaft IS2 with the power source.

The first and second clutches CL1 and CL2 may be conventional multi-plate clutches of wet type, but are not limited to this. The first and second clutches CL1 and CL2 may be conventional multi-plate clutches of dry type. The first and second clutches CL1 and CL2 may be controlled by a hydraulic control system.

The first and second input shafts IS1 and IS2 are disposed on the same axis.

A front end portion of the first input shaft IS1 is selectively connected to an output side of the power source through the first clutch CL1.

First, second, and third input gears G1, G2, and G3 are disposed on an exterior circumference of a rear end portion of the first input shaft IS1 with predetermined distances. The first, second, and third input gears G1, G2, and G3 are disposed in a named sequence from the front side to the rear side.

The second input shaft IS2 is a hollow shaft and the first input shaft IS1 is inserted in the second input shaft IS2 without rotational interference therebetween. A front end portion of the second input shaft IS2 is selectively connected to the output side of the power source through the second clutch CL2.

Fourth, fifth, and sixth input gears G4, G5, and G6 are disposed on the second input shaft IS2 with predetermined distances. The fourth, fifth, and sixth input gears G4, G5, and G6 are disposed in a named sequence from the front side to the rear side.

At this time, the first, second, and third input gears G1, G2, and G3 are disposed at a rear end portion of the first input shaft IS1 penetrating the second input shaft IS2.

The first, second, third, fourth, fifth, and sixth input gears G1, G2, G3, G4, G5, and G6 are input gears operating at each speed. The first input gear G1 is an input gear operated at a seventh forward speed and a third forward speed, the second input gear G2 is an input gear operated at a first forward speed, the third input gear G3 is an input gear operated at a fifth forward speed, the fourth input gear G4 is an input gear operated at a reverse speed, the fifth input gear G5 is an input gear operated at a sixth forward speed, and the sixth input gear G6 is an input gear operated at a fourth forward speed and a second forward speed.

That is, the input gears for odd-numbered speeds are disposed on the first input shaft IS1, and the input gears for even-numbered speeds and the reverse speed are disposed on the second input shaft IS2.

In addition, first and second output shafts OS1 and OS2 are disposed in parallel with and apart from the first and second input shafts IS1 and IS2. The first and second output shafts OS1 and OS2 receive torque from each input gear, convert the torque, and output the converted torque.

A sixth speed gear D6 and a fourth speed gear D4 are adjacently disposed on the first output shaft OS1, and a seventh speed gear D7 and a fifth speed gear D5 are adjacently disposed on the first output shaft OS1. In addition, a third speed gear D3 and a first speed gear D1 are adjacently disposed on the second output shaft OS2, and a reverse speed gear RG and a second speed gear D2 are adjacently disposed on the second output shaft OS2.

A first synchronizer module SL1 is disposed on the second output shaft OS2 between the third speed gear D3 and the first speed gear D1 so as to operably connect the third speed gear D3 or the first speed gear D1 to the second output shaft OS2, and a second synchronizer module SL2 is disposed on the second output shaft OS2 between the reverse speed gear RG and the second speed gear D2 so as to operably connect the reverse speed gear RG or the second speed gear D2 to the second output shaft OS2. In addition, third synchronizer module SL3 is disposed on the first output shaft OS1 between the sixth speed gear D6 and the fourth speed gear D4 so as to operably connect the sixth speed gear D6 or the fourth speed gear D4 to the first output shaft OS1, and a fourth synchronizer module SL4 is disposed on the first output shaft OS1 between the seventh speed gear D7 and the fifth speed gear D5 so as to operably connect the seventh speed gear D7 or the fifth speed gear D5 to the first output shaft OS1.

The third speed gear D3 is engaged with the first input gear G1 on the first input shaft IS1 and the first speed gear D1 is engaged with the second input gear G2 on the first input shaft IS1.

The reverse speed gear RG is operably connected to the fourth input gear G4 on the second input shaft IS2 through a reverse speed device and the second speed gear D2 is engaged with the sixth input gear G6 on the second input shaft IS2.

The sixth speed gear D6 is engaged with the fifth input gear G5 on the second input shaft IS2 and the fourth speed gear D4 is engaged with the sixth input gear G6 on the second input shaft IS2.

The seventh speed gear D7 is engaged with the first input gear G1 on the first input shaft IS1 and the fifth speed gear D5 is engaged with the third input gear G3 on the first input shaft IS1.

The reverse speed device includes a reverse speed shaft RS disposed in parallel with the second output shaft OS2. A reverse input gear RIG is fixedly disposed on a side portion of the reverse speed shaft RS and is engaged with the fourth input gear G4 on the second input shaft IS2. A reverse output gear ROG is fixedly disposed on the other side portion of the reverse speed shaft RS and is engaged with the reverse speed gear RG on the second output shaft OS2.

If the second input shaft IS2 is rotated, the reverse speed device transmits torque of the fourth input gear G4 to the reverse speed gear RG through the reverse input gear RIG and the reverse output gear ROG. In this process, rotation speed of the fourth input gear G4 decreases.

In addition, the torque transmitted to the first and second output shafts OS1 and OS2 is transmitted to a differential apparatus through the first and second output gears OG1 and OG2 fixedly mounted respectively at front end portions of the first and second output shafts OS1 and OS2.

In the power transmitting apparatus for a vehicle according to the first exemplary embodiment of the present invention, the seventh speed gear D7 on the first output shaft OS1 and the third speed gear D3 on the second output shaft OS2 are engaged with the first input gear G1 on the first input shaft IS1 simultaneously, and the fourth speed gear D4 on the first output shaft OS1 and the second speed gear D2 on the second output shaft OS2 are engaged with the sixth input gear G6 on the second input shaft IS2 simultaneously.

Since the first, second, third, and fourth synchronizer modules SL1, SL2, SL3, and SL4 are well known to a person of an ordinary skill in the art, detailed description thereof will be omitted. Sleeves SEL1, SEL2, SEL3, and SEL4 applied respectively to the first, second, third, and fourth synchronizer modules SL1, SL2, SL3, and SL4, as well known to a person of an ordinary skill in the art, are operated by additional actuators and the actuators are controlled by a transmission control unit.

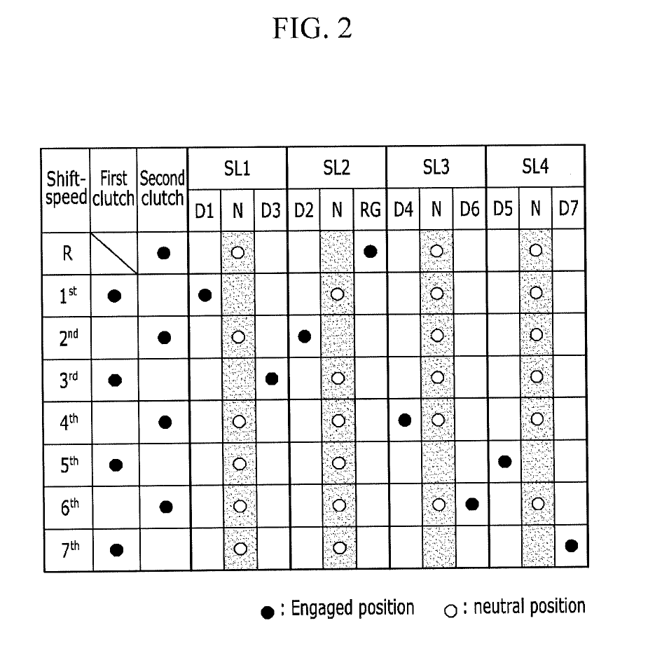

FIG. 2 is an operational chart of a power transmitting apparatus for a vehicle according to the first exemplary embodiment of the present invention.

[Reverse Speed]

At the reverse speed R, the second output shaft OS2 and the reverse speed gear RG are operably connected through the sleeve SEL2 of the second synchronizer module SL2. After that, the second clutch CL2 is operated. Then, shift to the reverse speed is completed.

[First Forward Speed]

At the first forward speed 1^{st}, the first speed gear D1 and the second output shaft OS2 are operably connected through the sleeve SEL1 of the first synchronizer module SL1. After that, the first clutch CL1 is operated. Then, shift to the first forward speed is completed.

[Second Forward Speed]

If vehicle speed increases at the first forward speed 1^{st} and shift to the second forward speed 2^{nd} is necessary, the second speed gear D2 and the second output shaft OS2 are operably connected through the sleeve SEL2 of the second synchronizer module SL2. After that, the first clutch CL1 is released and the second clutch CL2 is operated. Then, the shift to the second forward speed is completed.

After the shift to the second forward speed is completed, the sleeve SEL1 of the first synchronizer module SL1 is moved to a neutral position.

[Third Forward Speed]

If the vehicle speed increases at the second forward speed 2^{nd} and shift to the third forward speed 3^{rd} is necessary, the third speed gear D3 and the second output shaft OS2 are operably connected through the sleeve SEL1 of the first synchronizer module SL1. After that, the second clutch CL2 is released and the first clutch CL1 is operated. Then, the shift to the third forward speed is completed.

After the shift to the third forward speed is completed, the sleeve SEL2 of the second synchronizer module SL2 is moved to a neutral position.

[Fourth Forward Speed]

If the vehicle speed increases at the third forward speed 3^{rd} and shift to the fourth forward speed 4^{th} is necessary, the fourth speed gear D4 and the first output shaft OS1 are operably connected through the sleeve SEL3 of the third synchronizer module SL3. After that, the first clutch CL1 is released and the second clutch CL2 is operated. Then, the shift to the fourth forward speed is completed.

After the shift to the fourth forward speed is completed, the sleeve SEL1 of the first synchronizer module SL1 is moved to a neutral position.

[Fifth Forward Speed]

If the vehicle speed increases at the fourth forward speed 4^{th} and shift to the fifth forward speed 5^{th} is necessary, the fifth speed gear D5 and the first output shaft OS1 are operably connected through the sleeve SEL4 of the fourth synchronizer module SL4. After that, the second clutch CL2 is released and the first clutch CL1 is operated. Then, the shift to the fifth forward speed is completed.

After the shift to the fifth forward speed is completed, the sleeve SEL3 of the third synchronizer module SL3 is moved to a neutral position.

[Sixth Forward Speed]

If the vehicle speed increases at the fifth forward speed 5^{th} and shift to the sixth forward speed 6^{th} is necessary, the sixth speed gear D6 and the first output shaft OS1 are operably connected through the sleeve SEL3 of the third synchronizer module SL3. After that, the first clutch CL1 is released and the second clutch CL2 is operated. Then, the shift to the sixth forward speed is completed.

After the shift to the sixth forward speed is completed, the sleeve SEL4 of the fourth synchronizer module SL4 is moved to a neutral position.

[Seventh Forward Speed]

If the vehicle speed increases at the sixth forward speed 6^{th} and shift to the seventh forward speed 7^{th} is necessary, the seventh speed gear D7 and the first output shaft OS1 are operably connected through the sleeve SEL4 of the fourth synchronizer module SL4. After that, the second clutch CL2 is released and the first clutch CL1 is operated. Then, the shift to the seventh forward speed is completed.

After the shift to the seventh forward speed is completed, the sleeve SEL3 of the third synchronizer module SL3 is moved to a neutral position.

In the power transmitting apparatus for a vehicle according to the first exemplary embodiment of the present invention, the seventh speed gear D7 on the first output shaft OS1 and the third speed gear D3 on the second output shaft OS2 are engaged with the first input gear G1 on the first input shaft IS1 simultaneously, and the fourth speed gear D4 on the first output shaft OS1 and the second speed gear D2 on the second output shaft OS2 are engaged with the sixth input gear G6 on the second input shaft IS2 simultaneously.

Since seven forward speeds can be achieved but the number of input gears disposed on the input shafts can be minimized, a length of a transmission may be shortened. Since layout change of engine compartments and other design change may be prevented, cost may be curtailed.

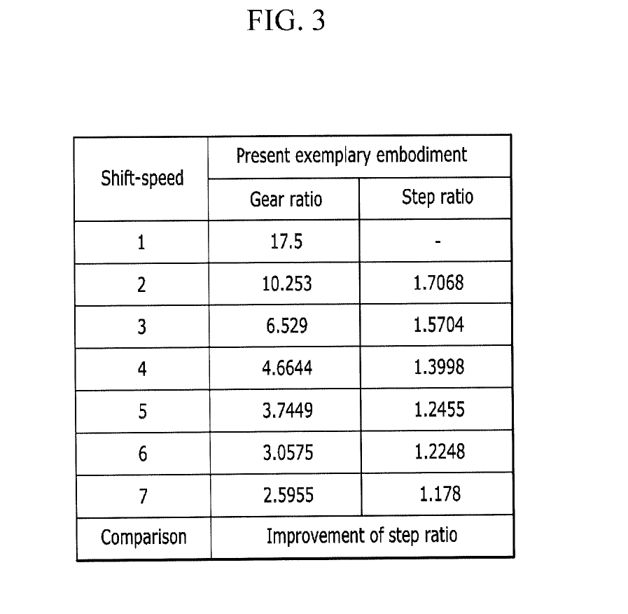

FIG. 3 is a table illustrating gear ratios and step ratios of power transmitting apparatus for a vehicle according to the first exemplary embodiment of the present invention.

Referring to FIG. 3, step ratios between shift-speeds are large at a low-speed region where higher output is necessary but are small at a high-speed region where quick shift and driving efficiency is necessary. The seventh speed gear D7 and the third speed gear D3 having comparatively large gear ratio difference therebetween are engaged with the first input gear G1 simultaneously, and the fourth speed gear D4 and the second speed gear D2 having comparatively large gear ratio difference therebetween are engaged with the sixth input gear G6 simultaneously in the exemplary embodiment of the present invention. Therefore, drivability and fuel economy may be improved by preventing distortion of step ratios at the high-speed region.

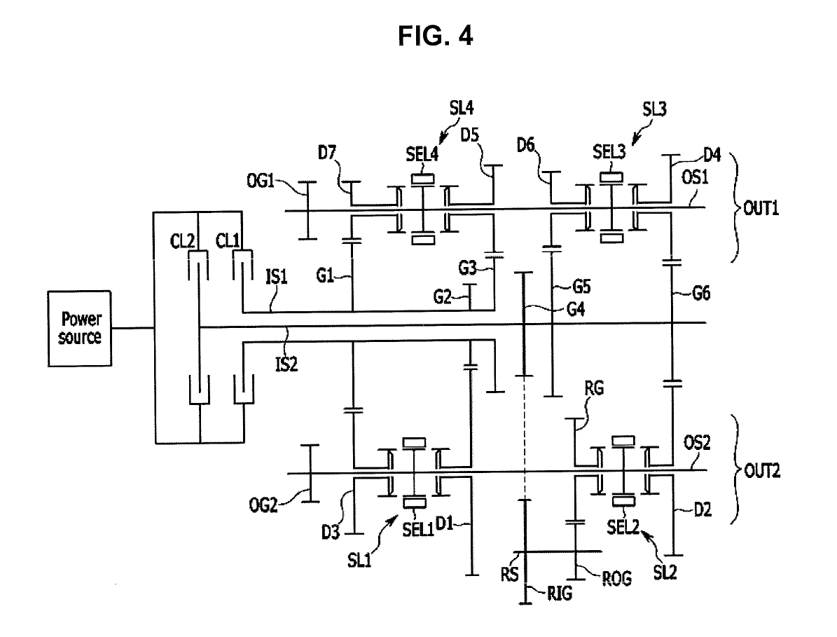

FIG. 4 is a schematic diagram of a power transmitting apparatus for a vehicle according to the second exemplary embodiment of the present invention.

Referring to FIG. 4, the even-numbered speed gears, the reverse speed gear and the second and third synchronizer modules SL2 and SL3 are disposed at a front portion, and the odd-numbered speed gears and the first and fourth synchronizer modules SL1 and SL4 are disposed at a rear portion in the first exemplary embodiment, but the even-numbered speed gears, the reverse speed gear and the second and third synchronizer modules SL2 and SL3 are disposed at the rear portion, and the odd-numbered speed gears and the first and fourth synchronizer modules SL1 and SL4 are disposed at the front portion in the second exemplary embodiment.

For this purpose, the first input shaft IS1 is the hollow shaft, and the first, second, and third input gears G1, G2, and G3 are sequentially disposed at an exterior circumference of the first input shaft IS1 in the second exemplary embodiment. The second input shaft IS2 penetrates the first input shaft IS1, and the fourth, fifth, and sixth input gears G4, G5, and G6 are sequentially disposed at an exterior circumference of the second input shaft IS2.

In addition, the fourth synchronizer module SL4 is disposed at the front end portion of the first output shaft OS1, the seventh speed gear D7 is engaged with the first input gear G1, and the fifth speed gear D5 is engaged with the third input gear G3. The third synchronizer module SL3 is disposed at the rear end portion of the first output shaft OS1, the sixth speed gear D6 is engaged with the fifth input gear G5, and the fourth speed gear D4 is engaged with the sixth input gear G6.

In addition, the first synchronizer module SL1 is disposed at the front end portion of the second output shaft OS2, the third speed gear D3 is engaged with the first input gear G1, and the first speed gear D1 is engaged with the second input gear G2. The second synchronizer module SL2 is disposed at the rear end portion of the second output shaft OS2, the reverse speed gear RG is operably connected to the fourth input gear G4 through the reverse speed device, and the second speed gear D2 is engaged with the sixth input gear G6.

The seventh speed gear D7 on the first output shaft OS1 and the third speed gear D3 on the second output shaft OS2 are engaged with the first input gear G1 on the first input shaft IS1 simultaneously, and the fourth speed gear D4 on the first output shaft OS1 and the second speed gear D2 on the second output shaft OS2 are engaged with the sixth input gear G6 on the second input shaft IS2 simultaneously in the power transmitting apparatus for a vehicle according to the second exemplary embodiment of the present invention.

Since technical characteristics and principles of the second exemplary embodiment are the same as those of the first exemplary embodiment, detailed description thereof will be omitted.

The highest shift-speed (N^{th}) speed gear and the (N−4)^{th} speed gear are simultaneously engaged with any one input gear on the first input shaft, and the (N−3)^{th} speed gear and the (N−5)^{th} speed gear are simultaneously engaged with any one input gear on the second input shaft according to an exemplary embodiment of the present invention. Therefore, the number of input gears disposed on the input shafts can be minimized and a length of a transmission may be reduced. In addition, since layout change of engine compartments and other design change may be prevented, cost may be curtailed.

Since the speed gears having comparatively large gear ratio different therebetween are simultaneously engaged to one input gear, drivability and fuel economy may be improved by preventing distortion of step ratios at the high-speed region.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A power transmitting apparatus for a vehicle comprising:
first and second input shafts selectively receiving torque of a power source through first and second clutches;
first and second output shafts disposed in parallel with the first and second input shafts;
a plurality of input gears disposed on the first and second input shafts; and
at least six speed gears selectively connected to the first and second output shafts through a plurality of synchronizer modules,
wherein each speed gear is always engaged with each input gear such that the torque of the power source is changed by selective operation of the plurality of synchronizer modules and the changed torque is transmitted to the first output shaft or the second output shaft,
wherein one of the speed gears on the first output shaft and one of the speed gears on the second output shaft are engaged to any one of the input gears on the first input shaft, the one speed gear on the first output shaft is one of a highest shift-speed (N^{th}) speed gear and an (N−4)^{th} speed gear, and the one speed gear on the second output shaft is the other of the N^{th} speed gear and the (N−4)^{th} speed gear, and
wherein another speed gear on the first output shaft and another speed gear on the second output shaft are engaged to any one of the input gears on the second input shaft, another speed gear on the first output shaft is one of an (N−3)^{th} speed gear and an (N−5)^{th} speed gear, and another speed gear on the second output shaft is the other of the (N−3)^{th} speed gear and the (N−5)^{th} speed gear.

2. The power transmitting apparatus of claim 1, wherein the highest shift-speed (N^{th}) is any one of the sixth forward speed to the tenth forward speed.

3. The power transmitting apparatus of claim 1, wherein the second input shaft is a hollow shaft and the first input shaft penetrates the second input shaft and is disposed coaxially with the second input shaft.

4. The power transmitting apparatus of claim 3, wherein first, second, and third input gears of the input gears are sequentially disposed on the first input shaft, and fourth, fifth, and sixth input gears of the input gears are sequentially disposed on the second input shaft.

5. The power transmitting apparatus of claim 4,
wherein the speed gears include a reverse speed gear, and
wherein the power transmitting apparatus further comprises:
a reverse speed device including a reverse speed shaft disposed in parallel with the second output shaft;
a reverse input gear disposed on the reverse speed shaft and engaged with any one input gear on the second input shaft; and
a reverse output gear disposed on the reverse speed shaft and engaged with the reverse speed gear.

6. The power transmitting apparatus of claim 5, wherein the fourth input gear on the second input shaft is engaged with the reverse input gear.

7. The power transmitting apparatus of claim 1, wherein the first input shaft is a hollow shaft and the second input shaft penetrates the first input shaft and is disposed coaxially with the first input shaft.

8. The power transmitting apparatus of claim 7, wherein first, second, and third input gears of the input gears are sequentially disposed on the first input shaft, and fourth, fifth, and sixth input gears of the input gears are sequentially disposed on the second input shaft.

9. The power transmitting apparatus of claim 8,
wherein the speed gears include a reverse speed gear, and
wherein the power transmitting apparatus further comprises:
a reverse speed device including a reverse speed shaft disposed in parallel with the second output shaft;
a reverse input gear disposed on the reverse speed shaft and engaged with any one input gear on the second input shaft; and
a reverse output gear disposed on the reverse speed shaft and engaged with the reverse speed gear.

10. The power transmitting apparatus of claim 9, wherein the fourth input gear on the second input shaft is engaged with the reverse input gear.

11. A power transmitting apparatus for a vehicle, the apparatus comprising:
first and second input shafts selectively receiving torque of a power source through first and second clutches;
first and second output shafts disposed in parallel with the first and second input shafts;
a plurality of input gears disposed on the first and second input shafts; and
eight speed gears including a reverse speed gear selectively connected to the first and second output shafts through a plurality of synchronizer modules,
wherein each speed gear is always engaged with each input gear such that the torque of the power source is changed by selective operation of the plurality of synchronizer modules and the changed torque is transmitted to the first output shaft or the second output shaft, and
wherein a seventh speed gear on the first output shaft and a third speed gear on the second output shaft are engaged with any one input gear on the first input shaft, and a fourth speed gear on the first output shaft and a second speed gear on the second output shaft are engaged with any one input gear on the second input shaft.

12. The power transmitting apparatus of claim 11,
wherein the second input shaft is a hollow shaft and the first input shaft penetrates the second input shaft, and
wherein first, second, and third input gears are sequentially disposed on the first input shaft, and fourth, fifth, and sixth input gears are sequentially disposed on the second input shaft.

13. The power transmitting apparatus of claim 12, further comprising:
a reverse speed device including a reverse speed shaft disposed in parallel with the second output shaft;
a reverse input gear disposed on the reverse speed shaft and engaged with any one input gear on the second input shaft; and
a reverse output gear disposed on the reverse speed shaft and engaged with the reverse speed gear.

14. The power transmitting apparatus of claim 13, wherein the fourth input gear on the second input shaft is engaged with the reverse input gear.

15. The power transmitting apparatus of claim 11,
wherein the first input shaft is a hollow shaft and the second input shaft penetrates the first input shaft, and
wherein first, second, and third input gears are sequentially disposed on the first input shaft, and fourth, fifth, and sixth input gears are sequentially disposed on the second input shaft.

16. The power transmitting apparatus of claim 15, further comprising:
a reverse speed device including a reverse speed shaft disposed in parallel with the second output shaft;
a reverse input gear disposed on the reverse speed shaft and engaged with any one input gear on the second input shaft; and
a reverse output gear disposed on the reverse speed shaft and engaged with the reverse speed gear.

17. The power transmitting apparatus of claim 16, wherein the fourth input gear on the second input shaft is engaged with the reverse input gear.
